(19) United States
(12) Patent Application Publication
(10) Pub. No.: US 2016/0278568 A1
(43) Pub. Date: Sep. 29, 2016

(54) Coffee Maker Device

(71) Applicant: Patrick Richter, Harvey, LA (US)

(72) Inventor: Patrick Richter, Harvey, LA (US)

(21) Appl. No.: 15/079,149

(22) Filed: Mar. 24, 2016

Related U.S. Application Data
(60) Provisional application No. 62/138,597, filed on Mar. 26, 2015.

(51) Int. Cl. A47J 31/057

(52) U.S. Cl. CPC A47J 31/057

(57) ABSTRACT

A coffee maker for producing coffee free of contaminants. The coffee maker includes a housing having a base, an upstanding portion, and a head. A carafe is adapted to be positioned on the base, wherein the carafe is disposed beneath the head of the coffee maker. A water reservoir composed of a ceramic material is disposed within the upstanding portion and is connected to a heating unit via a first elongated tube. A second elongated tube extends from the heating unit to a water distributor located within the head of the housing. A filter basket composed of a ceramic material is removably secured to the head beneath the water distributor, wherein the filter basket is adapted to hold a paper filter, coffee grounds, and receive hot water from the water distributor. The brewed coffee then flows through an opening in the filter basket into the carafe.

### CROSS REFERENCE TO RELATED APPLICATION

This application claims the benefit of U.S. Provisional Application No. 62/138,597 filed on Mar. 26, 2015. The above identified patent application is herein incorporated by reference in its entirety to provide continuity of disclosure.

### BACKGROUND OF THE INVENTION

The present invention relates to coffee makers. More specifically, the present invention provides a coffee maker device having ceramic components configured to preserve the purity of the water and coffee produced by the coffee maker by minimizing the possibility of contamination.

Conventional drip coffee makers are composed of various types of plastic. Plastic materials are lightweight, durable, and are inexpensive to produce. However, plastic materials are generally not well adapted to storing and containing hot liquids. When the plastic materials of the coffee maker are exposed to hot water or coffee, the plastic may leech into the coffee and water, contaminating the same. This effect may worsen over time as the coffee maker is subjected to extended use and exposure to hot liquids. As a result, the taste of the coffee is negatively affected by the addition of plastic contaminants. Further, the plastic that leeches into the coffee is then consumed by the user which can be detrimental to the user's health. Accordingly, an improved coffee maker that preserves the purity of the coffee and water is desired.

Devices have been disclosed in the prior art that relate to coffee makers. These include devices that have been patented and published in patent application publications. These devices generally relate to coffee makers having various constructions, such as U.S. Pat. No. 6,253,662, U.S. Published Patent Application No. 2002/0005367, U.S. Pat. No. 8,826,804, U.S. Pat. No. 6,402,103, U.S. Published Patent Application No. 2013/0247776, and U.S. Pat. No. 2,359,936.

These prior art devices have several known drawbacks. The devices in the prior art fail to provide a coffee maker having ceramic components so as to prevent plastic materials from leeching into the coffee being brewed therein. Further, such devices having plastic components are subject to damage or degradation over time. The prior art devices do not provide a removable ceramic filter basket and a ceramic water reservoir.

In light of the devices disclosed in the prior art, it is submitted that the present invention substantially diverges in design elements from the prior art and consequently it is clear that there is a need in the art for an improvement to existing coffee maker devices. In this regard the instant invention substantially fulfills these needs.

### SUMMARY OF THE INVENTION

In view of the foregoing disadvantages inherent in the known types of coffee makers now present in the prior art, the present invention provides a new coffee maker wherein the same can be utilized for providing convenience for the user when making coffee.

The present invention provides a coffee maker device that preserves the purity of the coffee brewed therein. The coffee maker comprises a housing having a base, an upstanding portion, and a head. The upstanding portion comprises a water reservoir composed of a ceramic material. A heater heats the water from the reservoir and an elongated tube extends to a water distributer disposed within the head. A filter basket is removably securable to the head beneath the water distributer, wherein the filter basket is composed of a ceramic material. In this way, the components that contact the water are composed of ceramic or metal so as to prevent overheating of plastic components. A glass carafe is removably positioned on the base and beneath the filter basket for receiving coffee brewed via the coffee maker.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the coffee maker.

FIG. 2 shows a side cross sectional view of the coffee maker.

FIG. 3 shows a perspective view of the filter basket of the coffee maker.

### DETAILED DESCRIPTION OF THE INVENTION

Reference is made herein to the attached drawings. Like reference numerals are used throughout the drawings to depict like or similar elements of the coffee maker. For the purposes of presenting a brief and clear description of the present invention, the preferred embodiment will be discussed as used for brewing coffee. The figures are intended for representative purposes only and should not be considered to be limiting in any respect.

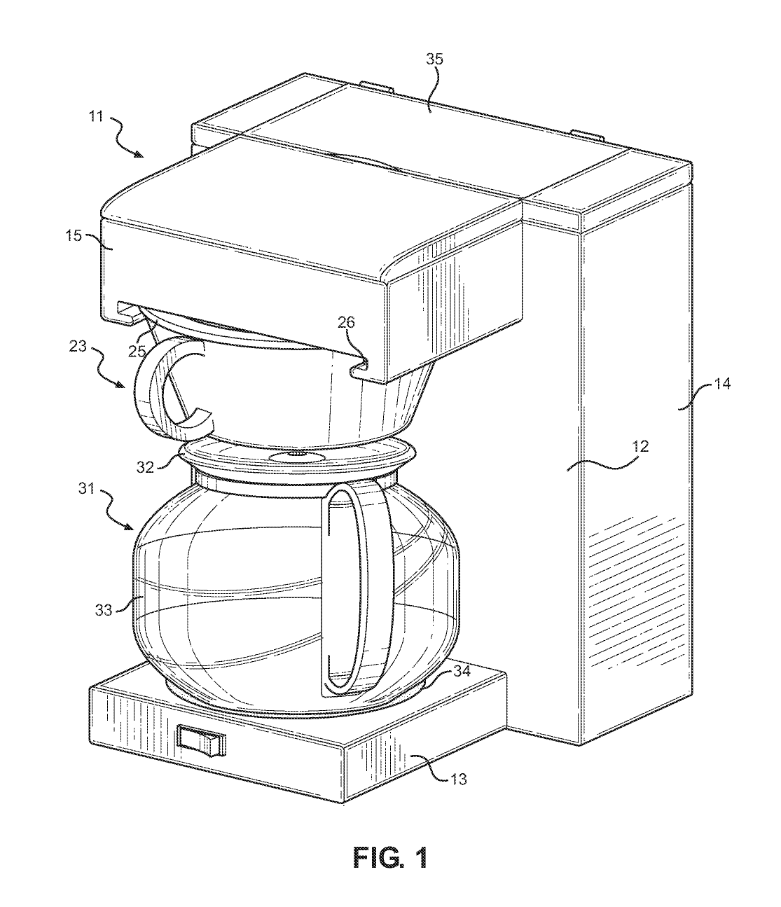

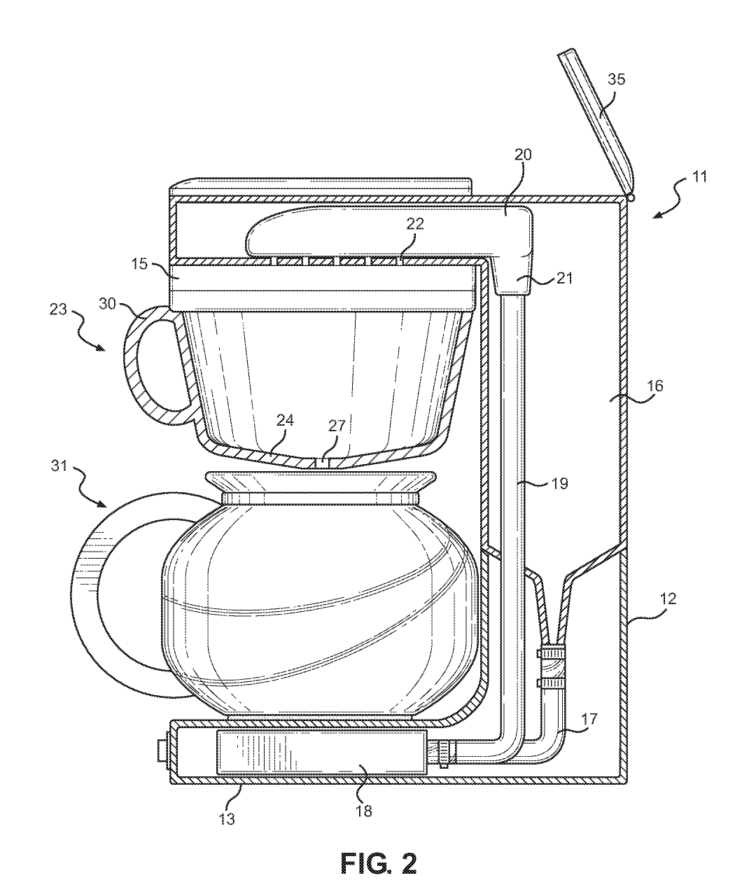

Referring now to FIGS. 1 and 2, there is shown a perspective view of the coffee maker and a side cross sectional view of the coffee maker, respectively. The coffee maker 11 comprises a housing 12 having a base 13, an upstanding portion 14, and a head 15. The housing 12 is primarily composed of plastic so as to provide a durable and shock-proof housing 12 that protects the components of the coffee maker 11 disposed therein. The upstanding portion 14 comprises a water reservoir 16 therein adapted to store a quantity of water for use in brewing coffee. The water reservoir 16 is composed of a ceramic material. The ceramic material allows the water to retain its purity and eliminates the possibility of debris or contaminants entering the water. In some embodiments, the ceramic water reservoir 16 comprises padding or cushioning on an exterior surface thereof so as to protect the water reservoir 16 from damage. The upper end of the upstanding portion 14 comprises a pivoting lid 35 thereon that can be moved between an open and closed configuration so as to allow the user to access the water reservoir 16 therein. The user may open the lid 35 so as to fill the water reservoir 16 with water for use in brewing coffee.

A first elongated tube 17 extends from a lower end of the water reservoir 16 and is adapted to carry water from the water reservoir 16 to a heating unit 18 disposed in the base 13 of the housing 12. The heating unit 18 comprises electrical resistance heating coils that produce heat when electrical current is provided therethrough. The heating unit 18 serves to heat the water provided by the water reservoir 16. The heating unit 18 also provides heat for a heating pad 34 disposed on the upper surface of the base 13, wherein the heating pad 34 serves to warm the coffee held within a carafe 31 having a body 33 and an open upper end 32. A second elongated tube 19 extends from the heating unit 18 towards the head 15 of the housing 12. The upper end of the second elongated tube 19 includes a water distributor 20 thereon. Preferably, the first and second elongated tubes 17, 19 are composed of stainless steel. The use of stainless steel prevents the water from contacting any plastic components or other materials that may leech into the water.

The water distributor 20 includes a body having an interior volume and an opening 21 that receives the second elongated tube 19 so that the second elongated tube 19 can transport the heated water into the interior volume of the water distributor 20. The water distributor 20 further includes a plurality of apertures 22 on a lower surface thereof, wherein the plurality of apertures 22 allows the water fed into the body of the water distributor 20 to escape therefrom and flow into a filter basket 23. Preferably, the water distributor 20 is composed of a ceramic material so as to prevent contamination of the heated water as it flows therethrough.

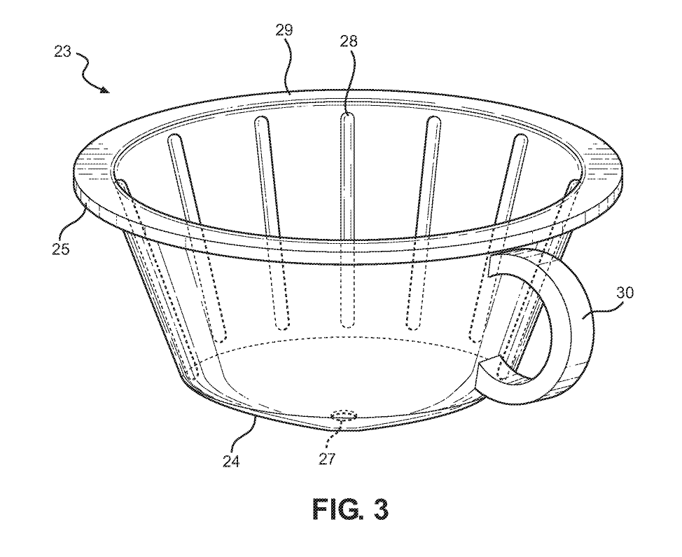

Referring now to FIG. 3, there is shown a perspective view of the filter basket of the coffee maker. A filter basket 23 composed of a ceramic material is removably secured to the head 15 of the housing 12. The filter basket 23 comprises a lower end 24, upstanding sidewalls, and an open upper end 29. The upper end preferably includes an outwardly extending lip 25 thereon. The lip 25 is adapted to engage with grooves 26 disposed on the head 15 of the housing 12 as shown in FIG. 1 so that the filter basket 23 can be removably secured to the head 15 by engaging the lip 25 within the grooves 26. The lower end 24 of the filter basket 23 comprises a central opening 27 thereon so as to allow liquid to escape therefrom. Preferably, the lower end 24 slopes downward toward the opening 27 so as to allow water to flow towards the opening 27. The interior of the filter basket 23 comprises a plurality of ridges 28 therein, wherein the ridges 28 help to hold a paper filter in position within the filter basket 23 and also help to control the flow of liquid therein. The water and coffee grounds steep in the filter basket 23 for an extended period of time as the water passes through the grounds and through the paper filter. Thus, it is important that the filter basket 23 is composed of a ceramic material that does not contaminate the coffee brewed therein.

Ceramic materials include clay and porcelain, in addition to various types of earthenware and stoneware. Ceramics are resistant to chemical erosion that may occur in an acid or caustic environment. Further, ceramics can withstand extremely high temperatures. As a result, ceramic materials are well suited to holding boiling or near-boiling water that is used to brew coffee without damage to the ceramic and without particles of the ceramic material entering the liquid.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A coffee maker, comprising:
a housing having a base, an upstanding portion, and a head;
a water reservoir disposed within the upstanding portion of the housing;
a first elongated tube extending from a lower portion of the water reservoir and adapted to carry water from the water reservoir to a heating unit disposed in the base;
a second elongated tube extending from the heating unit to a water distributor disposed within the head of the housing, wherein the water distributor includes a body having a plurality of apertures thereon;
a filter basket removably secured to the head beneath the water distributor, wherein the filter basket is composed of a ceramic material so as to prevent water held therein from becoming contaminated.

2) The coffee maker of claim 1, wherein the first elongated tube is composed of stainless steel.

3) The coffee maker of claim 2, wherein the second elongated tube is composed of stainless steel.

4) The coffee maker of claim 1, wherein the water reservoir is composed of a ceramic material.

5) The coffee maker of claim 1, wherein the water distributor is composed of a ceramic material.

6) The coffee maker of claim 1, wherein the water distributor comprises a body having an interior volume and a plurality of apertures on a lower surface thereof through which water may flow into the filter basket positioned therebeneath.

7) The coffee maker of claim 1, wherein the heating unit comprises electrical resistance coils.

8) The coffee maker of claim 1, wherein the filter basket comprises a base, upstanding sidewalls, and an open upper end, wherein the open upper end includes a lip extending therefrom.

9) The coffee maker of claim 8, wherein the base of the filter basket slopes downward towards a central opening.
